(19) United States
(12) Patent Application Publication
(10) Pub. No.: US 2015/0186140 A1
(43) Pub. Date: Jul. 2, 2015

(54) OPCODE TRAPPING

(71) Applicants: Bret L. Toll, Hillsboro, OR (US); Buford M. Guy, Austin, TX (US); Ronak Singhal, Portland, OR (US); Glenn J. Hinton, Portland, OR (US); Mishali Naik, Santa Clara, CA (US)

(72) Inventors: Bret L. Toll, Hillsboro, OR (US); Buford M. Guy, Austin, TX (US); Ronak Singhal, Portland, OR (US); Glenn J. Hinton, Portland, OR (US); Mishali Naik, Santa Clara, CA (US)

(21) Appl. No.: 14/142,835

(22) Filed: Dec. 28, 2013

(51) Int. Cl. G06F 9/30

(52) U.S. Cl. CPC G06F 9/30145; G06F 9/30058

(57) ABSTRACT

Embodiments of an invention for opcode trapping are disclosed. In one embodiment, a processor includes an instruction unit to receive an instruction, the instruction unit having a match storage location in which to store a match value and a comparator. The comparator is to compare the match value to a portion of the instruction. Control of the processor is to be transferred to a trap handler if the comparator indicates that the match value matches the portion of the instruction.

### BACKGROUND

1. Field

The present disclosure pertains to the field of information processing.

2. Description of Related Art

Information processing systems may include a combination of hardware and software. To the extent that the operation of the information processing system is controlled by hardware, it may be difficult or impossible to change after the system has been manufactured and delivered to a customer. To the extent that the operation is controlled by software, it may also be difficult to change if the software has become widely distributed and/or re-used in different versions or products. However, in some systems it may be possible to change the operation by updating, patching, or otherwise modifying microcode to cause a different series of micro-instructions to be executed for a particular instruction.

### BRIEF DESCRIPTION OF THE FIGURES

The present invention is illustrated by way of example and not limitation in the accompanying figures.

FIG. 1 illustrates a system including a processor to trap on opcodes according to an embodiment of the present invention.

FIG. 2 illustrates a processor to trap on opcodes according to an embodiment of the present invention.

FIG. 3 illustrates a system architecture including opcode trapping according to an embodiment of the present invention.

FIG. 4 illustrates a method of trapping on opcodes according to an embodiment of the present invention.

### DETAILED DESCRIPTION

Embodiments of an invention for opcode trapping are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in the claims, unless otherwise specified the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type of storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

As described in the background section, a processor or a system may include microcode that may be updated, patched, or otherwise modified in order to change the operation of the processor or system. In a processor or system where such techniques are not feasible, or even in some in which they are, it may be desired to use an embodiment of the present invention to change the operation.

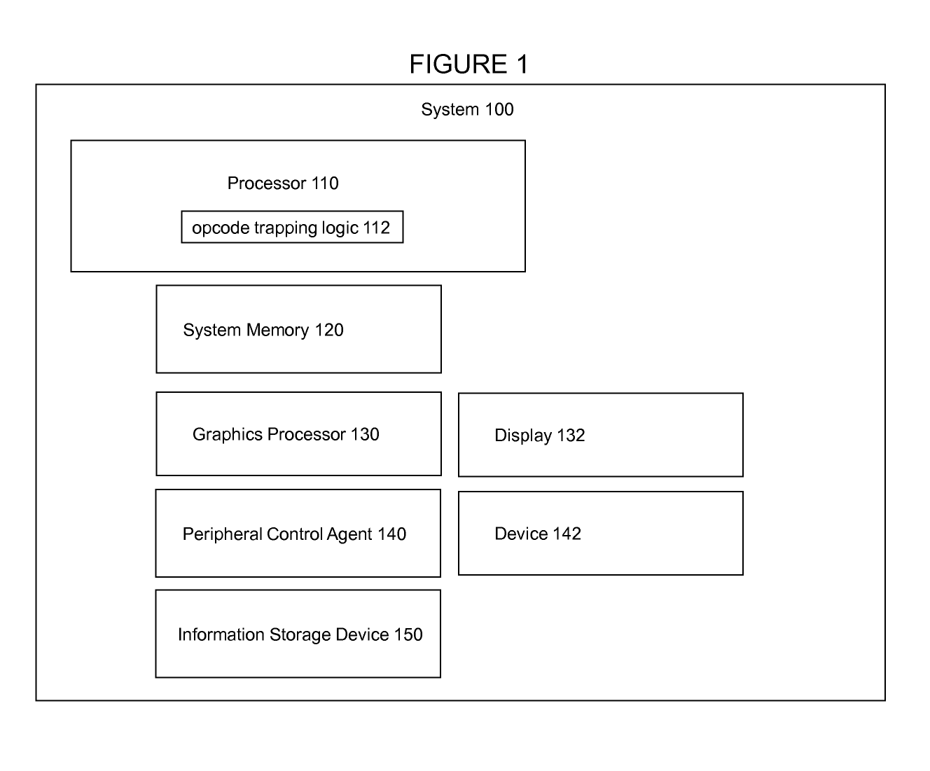

FIG. 1 illustrates system 100, an information processing system including a processor to trap on opcodes according to an embodiment of the present invention. System 100 may represent any type of information processing system, such as a server, a desktop computer, a portable computer, a set-top box, a hand-held device such as a tablet or a smart phone, or an embedded control system. System 100 includes processor 110, system memory 120, graphics processor 130, peripheral control agent 140, and information storage device 150. Systems embodying the present invention may include any number of each of these components and any other components or other elements, such as peripherals and input/output devices. Any or all of the components or other elements in this or any system embodiment, may be connected, coupled, or otherwise in communication with each other through any number of buses, point-to-point, or other wired or wireless interfaces or connections, unless specified otherwise. Any components or other portions of system 100, whether shown in FIG. 1 or not shown in FIG. 1, may be integrated or otherwise included on or in a single chip (a system-on-a-chip or SOC), die, substrate, or package.

System memory 120 may be dynamic random access memory or any other type of medium readable by processor 110. Graphics processor 130 may include any processor or other component for processing graphics data for display 132. Peripheral control agent 140 may represent any component, such as a chipset component, including or through which peripheral, input/output (I/O), or other components or devices, such as device 142 (e.g., a touchscreen, keyboard, microphone, speaker, other audio device, camera, video or other media device, network adapter, motion or other sensor, receiver for global positioning or other information, etc.) and/or information storage device 150, may be connected or coupled to processor 110. Information storage device 150 may include any type of persistent or non-volatile memory or storage, such as a flash memory and/or a solid state, magnetic, or optical disk drive.

Processor 110 may represent one or more processors or processor cores integrated on a single substrate or packaged within a single package, each of which may include multiple threads and/or multiple execution cores, in any combination. Each processor represented as or in processor 110 may be any type of processor, including a general purpose microprocessor, a special purpose processor, or a microcontroller. Processor 110 may be architected and designed to operate according to any instruction set architecture, with or without being controlled by microcode.

Support for opcode trapping may be implemented in a processor using any combination of circuitry and/or logic embedded in hardware, microcode, firmware, and/or other structures arranged as described below or according to any other approach, and is represented in FIG. 1 as opcode trapping logic 112.

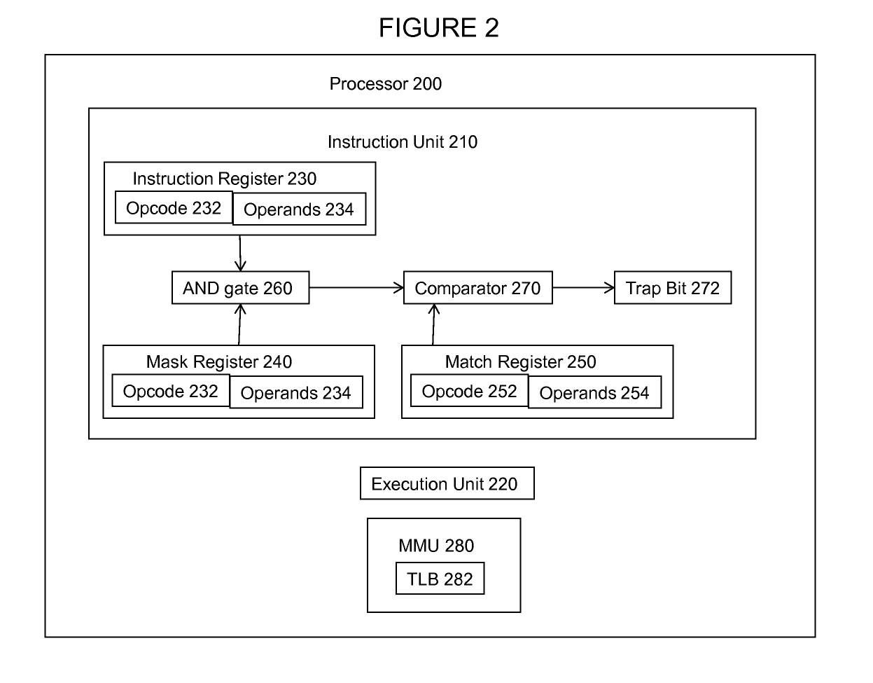

FIG. 2 illustrates processor 200, an embodiment of which may serve as processor 110 in system 100. Processor 200 may include instruction unit 210, execution unit 220, memory management unit (MMU) 280, and any other circuitry, structures, or logic not shown in FIG. 2. The functionality of opcode trapping logic 112, as introduced above and further described below, may be contained in or distributed among any of the labeled units or elsewhere in processor 200.

Instruction unit 210 may include any circuitry, logic, structures, and/or other hardware for fetching, receiving, decoding, interpreting, and/or scheduling instructions to be executed by processor 200. Execution unit 220 may include any circuitry, logic, structures, and/or other hardware, such as arithmetic units, logic units, floating point units, shifters, etc., for processing data and executing instructions.

MMU 280 may include any circuitry, logic, structures, and/or other hardware to manage the memory space of processor 200. Memory management logic supports the use of virtual memory to provide software with an address space for storing and accessing code and data that is larger than the address space of the physical memory in the system, e.g., system memory 120. The virtual memory space of processor 200 may be limited only by the number of address bits available to software running on the processor, while the physical memory space of processor 200 is further limited to the size of system memory 120. MMU 280 may support a memory management scheme, such as paging, to swap the executing software's code and data in and out of system memory 120 on an as-needed basis. As part of this scheme, the software may access the virtual memory space of the processor with an un-translated address that is translated by the processor to a translated address that the processor may use to access the physical memory space of the processor.

Accordingly, MMU 280 may include translation lookaside buffer (TLB) 282 to store translations of a virtual, logical, linear, or other un-translated address to a physical or other translated address, according to any known memory management technique, such as paging. To perform these address translations, MMU 280 may refer to one or more data structures stored in processor 200, system memory 120, any other storage location in system 100 not shown in FIG. 1, and/or any combination of these locations. The data structures may include page directories and page tables according to the architecture of any processor or processor family. One or more of the entries in such a data structure may hold access permissions indicating the allowable uses (e.g., read, write, and or execute) for which a page or other memory region or location may be accessed. Enforcement of such access permissions may include reporting a memory access violation in response to an unpermitted access attempt.

Returning to instruction unit 210, it may include instruction register 230, mask register 240, and match register 250, each of which may be a register or any other type of storage location. Instruction register 230 may be used to store an instruction to be decoded or otherwise handled by instruction unit 210 (the current instruction). Any instruction format may be used within the scope of the present invention. For example, an opcode field 232 may be used for an instruction opcode and operand field 234 may be used for one or more instruction operands. Instruction register 230 may be loaded by an instruction fetch from system memory 120 according to any known instruction fetch technique, such as through the advancement of an instruction pointer or through the use of a branch, jump, call, or other control transfer instruction.

Mask register 240 may be a programmable register available for software to use according to an embodiment of the present invention to hold a mask with which to determine which portion of instruction register 230 is to be used for trapping. Mask register 240 may be connected to a first input of bitwise logical AND gate 260 and instruction register 210 may be connected a second input of bitwise logical AND gate 260, such that the output of bitwise logical AND gate 260 reflects the portion of the current instruction that is selected by the contents of mask register 240. For example, the current opcode (or a portion thereof) may be selected by programming mask register 240 with all ones in opcode mask 242 (or a portion thereof) and all zeroes in operand mask 244. Similarly, one or more current operands (or portions thereof) may be selected by programming mask register 240 with all ones in that portion of operand mask 244 to be selected and all zeroes in the remainder of mask register 240.

Match register 250 may be a programmable register available for software to use according to an embodiment of the present invention to hold an opcode 252 and/or one or more operands 254 to be trapped, as further described below. Match register 250 may be connected to a first input of comparator 270 and the output of AND gate 260 may be connected a second input of comparator 270, such that the output of comparator 270 indicates whether the selected portion of the current instruction matches the opcode and/or operands which are to trigger a trap.

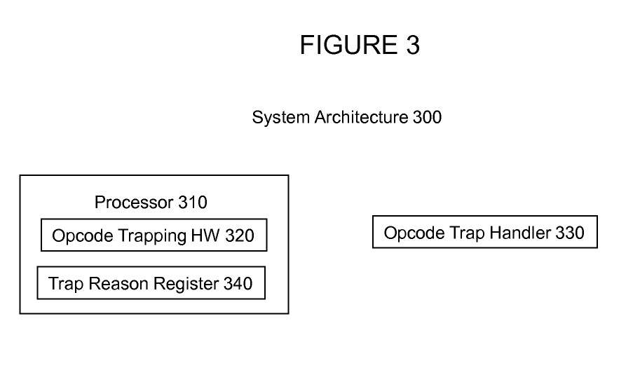

The output of comparator 270 may be used to trap (e.g., raise or cause an exception, interrupt, fault, or other control flow change event by setting opcode trap bit or indicator 272) to an opcode trap handler, such as opcode trap handler 330 in system architecture 300 of FIG. 3. FIG. 3 also shows a processor 310 having opcode trapping hardware 320, which may represent opcode trapping logic 112 of processor 110 or the opcode trapping hardware or logic of any other embodiment of the present invention.

Opcode trap handler 330 may represent a secure or hidden software, a virtualization layer or handler, or any other firmware or software to handle opcode traps according to an embodiment of the present invention. Handling of opcode traps by opcode trap handler 330 may include implementing updates, workarounds or bug fixes, adding new capabilities or functionality, implementing security, virtualization, system management, or other features, emulating or otherwise performing the function of a microcode patch, and/or any other desired actions.

Opcode trap handler 330 may be software having a supervisor, secure, system level, or other privilege level (a higher privilege level) that is more privileged than a user, normal, application level, or other privilege level (a lower privilege level) at which another process, thread, task, application, program, or software (e.g., that which invoked the instruction that resulted in the opcode trap) may run or execute, and/or opcode trap handler 330 may execute in a processor mode (privileged mode) that is more privileged than one or more other processor modes. In one embodiment, opcode trapping hardware 320 may be designed, implemented, and/or configured to perform opcode trapping according to an embodiment of the present invention only to an opcode trap handler having a higher privilege level and/or to a privileged mode.

Various other or additional features of opcode trapping logic are possible within various embodiments of the present invention. In an embodiment, opcode trapping logic saves or stores information that triggered the trap (e.g., the opcode and/or one or more operands) in a storage location in processor 310, such as trap reason register 340, or a memory location in system memory 350. Such a storage or memory location may be accessible only in a privileged mode and/or to software running at a higher privilege level. Trapping may also include saving or storing other or additional information (such as processor or machine mode of operation at the time of trapping, decoded or partially decoded operands, etc.) in such a storage or memory location.

In other embodiments, trapping may also or instead be triggered by other micro-architectural or other events, such as TLB misses, page faults, memory access violations, etc.

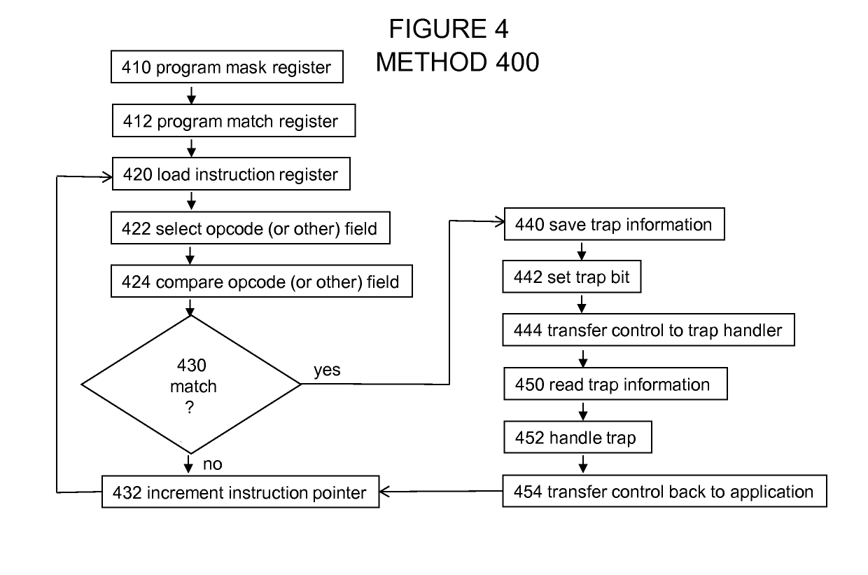

FIG. 4 illustrates method 400 including opcode trapping according to an embodiment of the present invention. Although method embodiments of the invention are not limited in this respect, reference may be made to elements of FIGS. 1, 2, and 3 to help describe the method embodiment of FIG. 4.

In box 410 of method 400, an opcode mask register such as mask register 220 is programmed, for example by opcode trap handler 330, with a mask to be used to select a portion of a current instruction (e.g., the opcode field). In box 412, an opcode match register such as match register 230 is programmed, for example by opcode trap handler 330, with a value of the portion of current instruction for which a trap is to be triggered (e.g., an opcode to trap).

In box 420, a current instruction is loaded into instruction register 210 in connection with the execution of a program, process, thread, or task executing or running on processor 200 (the application software). In box 422, the current instruction is masked (e.g., according to the mask in mask register 220) to select a portion of the current instruction to be checked. In box 424, the selected portion of the current instruction is compared to the particular value programmed into match register 230 (e.g., the opcode to trap).

In box 430, if the selected portion of the current instruction (e.g., the current opcode) matches the contents of match register 230 (e.g., the opcode to trap), then method 400 continues in box 440. If not, then in box 432, the next instruction of the application software replaces the current instruction (e.g., by incrementing or reloading an instruction pointer), and method 400 returns to box 420.

In box 440, trap information may be saved or stored, for example in trap reason register 340. In box 442, in response to the opcode trap, an opcode trap indicator (e.g., trap bit 272) may be set. In box 444, in response to the opcode trap, control of processor 200 is transferred to an opcode trap handler such as opcode trap handler 330.

In box 450, opcode trap handler 330 may read one or more trap reason registers, such as trap reason register 340, to determine the cause and/or conditions of the opcode trap. In box 452, opcode trap handler 330 handles the opcode trap, for example, by invoking one or more instructions to replace the trapped instruction.

In box 454, control of processor 300 may be returned to the application software, which, for example, may cause method 400 to continue in box 432.

In various embodiments of the present invention, the method illustrated in FIG. 4 may be performed in a different order, with illustrated boxes combined or omitted, with additional boxes added, or with a combination of reordered, combined, omitted, or additional boxes. Furthermore, method embodiments of the present invention are not limited to method 400 or variations thereof. Many other method embodiments (as well as apparatus, system, and other embodiments) not described herein are possible within the scope of the present invention.

Embodiments or portions of embodiments of the present invention, as described above, may be stored on any form of a machine-readable medium. For example, all or part of method 400 may be embodied in software or firmware instructions that are stored on a medium readable by processor 110, which when executed by processor 110, cause processor 110 to execute an embodiment of the present invention. Also, aspects of the present invention may be embodied in data stored on a machine-readable medium, where the data represents a design or other information usable to fabricate all or part of processor 110.

Thus, embodiments of an invention for opcode trapping have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
an instruction unit to receive an instruction, the instruction unit including
a match storage location in which to store a match value, and
a comparator to compare the match value to a portion of the instruction,
wherein control of the processor is to be transferred to a trap handler if the comparator indicates that the match value matches the portion of the instruction.

2. The processor of claim 1, wherein the portion of the instruction includes the first instruction.

3. The processor of claim 1, further comprising a mask storage location to select the portion of the instruction.

4. The processor of claim 3, wherein the portion of the instruction includes an opcode.

5. The processor of claim 3, wherein the portion of the instruction includes an operand.

6. The processor of claim 1, further comprising a trap indicator to be set if the comparator indicates that the match value matches the portion of the instruction.

7. The processor of claim 1, further comprising a trap reason storage location, wherein trap information is to be saved in the trap reason storage location if the comparator indicates that the match value matches the portion of the instruction.

8. The processor of claim 3, further comprising an instruction storage location in which to store the instruction.

9. The processor of claim 8, further comprising a bitwise logical AND gate, wherein the instruction storage location is connected to a first input of the bitwise logical AND gate, the mask storage location is connected to a second input of the bitwise logical AND gate, and the output of the bitwise logical AND gate is to indicate the portion of the instruction.

10. The processor of claim 9, wherein the match storage location is connected to a first input of the comparator, the output of the bitwise logical AND gate is connected to a second input of the comparator, and the output of the comparator is to indicate whether the instruction is to be trapped.

11. A method comprising:
programming, by software, a match value into a match storage location of a processor;
issuing, to the processor, an instruction;
comparing a portion of the instruction to the match value; and
trapping to a trap handler if the portion of the instruction matches the match value.

12. The method of claim 11, further comprising programming a mask into a mask storage location and selecting the portion of the instruction based on the mask.

13. The method of claim 12, wherein the portion of the instruction includes an opcode.

14. The method of claim 12, wherein the portion of the instruction includes an operand.

15. The method of claim 11, further comprising setting a trap indicator in response to determining that the match value matches the portion of the instruction.

16. The method of claim 11, further comprising saving trap reason information in a trap reason storage location in response to determining that the match value matches the portion of the instruction.

17. The method of claim 12, further comprising storing the instruction in an instruction storage location.

18. The method of claim 17, wherein selecting the portion of the instruction includes performing a bitwise logical AND operation using the instruction as a first input and the mask as a second input.

19. The method of claim 18, further comprising determining whether to trap the instruction based on comparing the match value to a result of the bitwise logical AND operation.

20. A system comprising:
a memory including a source location; and
a processor including
an instruction unit to receive an instruction, the instruction unit including
a match storage location in which to store a match value, and
a comparator to compare the match value to a portion of the instruction, wherein control of the processor is to be transferred to a trap handler if the comparator indicates that the match value matches the portion of the instruction.
